(19) United States
(12) Patent Application Publication
(10) Pub. No.: US 2026/0187950 A1
(43) Pub. Date: Jul. 2, 2026

(54) INTERACTION METHOD FOR VIRTUAL SCENE, ELECTRONIC DEVICE AND STORAGE MEDIUM

(71) Applicant: Beijing Zitiao Network Technology Co., Ltd., Haidian District, Beijing (CN)

(72) Inventors: Guangwei WANG, Beijing (CN); Huilin LIU, Beijing (CN); Xuefeng YANG, Beijing (CN); Zhenyi QU, Beijing (CN); Aixin HUO, Beijing (CN)

(21) Appl. No.: 19/130,047

(22) PCT Filed: Nov. 14, 2023
(86) PCT No.: PCT/CN2023/131419

§ 371 Date: May 14, 2025

(30) Foreign Application Priority Data
Nov. 14, 2022 (CN) 202211419634.1

(51) Int. Cl. G06T 19/20; G06T 11/23; G06T 13/60

(52) U.S. Cl. CPC G06T 19/20; G06T 11/23; G06T 13/60; G06T 2219/2016

(57) ABSTRACT

The present disclosure provides an interaction method for virtual scene, an electronic device and a storage medium. And the interaction method for virtual scene includes: determining a target sketch in the virtual scene, and the target sketch is obtained based on an operation inputted by a user; determining a target setting item of the virtual scene, and the target setting item is configured to set at least a portion of at least one of visual data or auditory data of the virtual scene; and updating a portion of the virtual scene corresponding to the target setting item according to an object category of an object in the target sketch.

The present application claims the priority and benefits of Chinese Patent Application No. 202211419634.1, filed Nov. 14, 2022, which is incorporated herein by reference in its entirety as part of the present application.

### TECHNICAL FIELD

Embodiments of the present disclosure relate to an interaction method for virtual scene, an apparatus, an electronic device and a storage medium.

### BACKGROUND

Virtual Reality (VR) technology can bring environmental immersion to users by simulating VR scenes. The simple interaction commands corresponding to the hardware are often inputted in the VR scene through hardware such as joystick buttons, which is a single interaction method with poor quickness, and the user interaction experience is poor.

### SUMMARY

Embodiments of the present disclosure provide an interaction method for virtual scene, an apparatus, an electronic device and a storage medium, which can enrich the interaction method in a VR scene and can improve the quickness of interaction, so that the user interaction experience can be improved.

In a first aspect, the embodiments of the present disclosure provide an interaction method for virtual scene, and the method includes:
determining a target sketch in the virtual scene, and the target sketch is obtained based on an operation inputted by a user;
determining a target setting item of the virtual scene, and the target setting item is configured to set at least a portion of at least one of visual data or auditory data of the virtual scene; and
updating a portion of the virtual scene corresponding to the target setting item according to an object category of an object in the target sketch.

In a second aspect, the embodiments of the present disclosure provide an interaction apparatus for virtual scene, and the apparatus includes: a sketch recognition module, a setting item determination module and a scene updating module.

The sketch recognition module is configured to determine a target sketch in the virtual scene, and the target sketch is obtained based on an operation inputted by a user;
the setting item determination module is configured to determine a target setting item of the virtual scene, and the target setting item is configured to set at least a portion of at least one of visual data or auditory data of the virtual scene; and
the scene updating module is configured to update a portion of the virtual scene corresponding to the target setting item according to an object category of an object in the target sketch.

In a third aspect, the embodiments of the present disclosure provide an electronic device, and the electronic device includes:
one or more processors; and
a storage apparatus is configured to store one or more programs,
when the one or more programs are executed by the one or more processors, the one or more processors implement the interaction method for the virtual scene as described in any of the embodiments of the present disclosure.

In a fourth aspect, the embodiments of the present disclosure further provide a storage medium including computer-executable instructions, and the computer-executable instructions when executed by a computer processor being used to implement the interaction method for the virtual scene as described in any of the embodiments of the present disclosure.

### BRIEF DESCRIPTION OF DRAWINGS

The above and other features, advantages and aspects of various embodiments of the present disclosure will become more apparent with reference to the following detailed description and in conjunction with the drawings. Throughout the drawings, the same or similar reference numerals denote the same or similar elements. It should be understood that the drawings are schematic and that parts and elements are not necessarily drawn to scale.

FIG. 1 is a schematic flow diagram of an interaction method for virtual scene provided by embodiments of the present disclosure;

FIG. 2 is a schematic diagram of an interface for determining a target sketch in an interaction method for virtual scene provided by embodiments of the present disclosure;

FIG. 3 is a schematic flow diagram of an interaction method for virtual scene provided by embodiments of the present disclosure;

FIG. 4 is a schematic diagram of an interface for updating an environment map in an interaction method for virtual scene provided by embodiments of the present disclosure;

FIG. 5 is a schematic flow diagram of an interaction method for virtual scene provided by embodiments of the present disclosure;

FIG. 6 is a schematic diagram of an interface for updating an object model in an interaction method for virtual scene provided by embodiments of the present disclosure;

FIG. 7 is a schematic flow diagram of an interaction method for virtual scene provided by embodiments of the present disclosure;

FIG. 8 is a schematic diagram of an interface for updating weather of a virtual scene in an interaction method for virtual scene provided by embodiments of the present disclosure;

FIG. 9 is a schematic diagram of an interface for updating geomorphic of a virtual scene in an interaction method for virtual scene provided by embodiments of the present disclosure;

FIG. 10 is a structural schematic diagram of an interaction apparatus for virtual scene provided by embodiments of the present disclosure; and

FIG. 11 is a structural schematic diagram of an electronic device provided by embodiments of the present disclosure.

### DETAILED DESCRIPTION

The embodiments of the present disclosure will be described in greater detail below with reference to the drawings. Although certain embodiments of the present disclosure are shown in the drawings, it should be understood, however, that the present disclosure may be realized in various forms and should not be construed as being limited to the embodiments set forth herein, but rather are provided for a more thorough and complete understanding of the present disclosure. It should be understood that the drawings and embodiments of the present disclosure are for exemplary purposes only and are not intended to limit the scope of protection of the present disclosure.

It should be understood that the individual steps documented in the method embodiments of the present disclosure may be performed in a different order, and/or in parallel. Furthermore, the method embodiments may include additional steps and/or omit performing the illustrated steps. The scope of the present disclosure is not limited in this regard.

The term “including” and variations thereof, as used herein, is open-ended, i.e., “including but not limited to.” The term “based on” is “based at least in part on.” The term “one embodiment” means “at least one embodiment”; the term “another embodiment” means “at least one additional embodiment”; the term “another embodiment” means “at least one other embodiment”; and the term “some embodiments” means “at least some embodiments”. Related definitions of other terms will be given in the following description.

It should be noted that the concepts of “first”, “second” and the like mentioned in the present disclosure are only used to differentiate different apparatuses, modules or units, and are not used to define the order or interdependence of the functions performed by these apparatuses, modules or units.

It should be noted that the modifications of “one” and “more than one” mentioned in the present disclosure are schematic rather than limiting, and the person skilled in the art should understand that, unless otherwise expressly stated in the context, they should be understood as “one or more”.

The names of the messages or information interacting between a plurality of apparatuses of the disclosure are used for illustrative purposes only and are not intended to limit the scope of those messages or information.

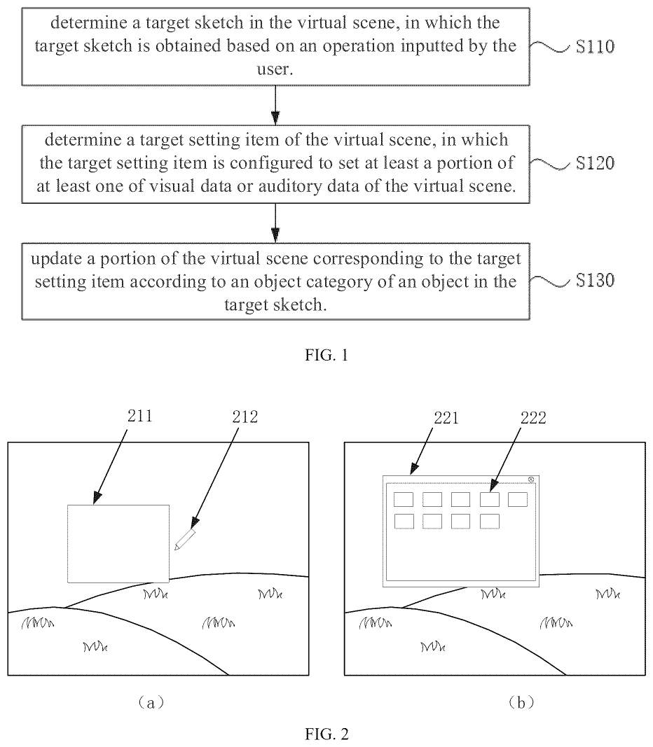

FIG. 1 is a schematic flow diagram of an interaction method for virtual scene provided by embodiments of the present disclosure. The embodiments of the present disclosure are suitable for situations where modifications are made to different parts of a virtual scene. The method may be performed by an interaction apparatus for virtual scene, the interaction apparatus may be implemented in the form of software and/or hardware, and the interaction apparatus may be configured in an electronic device, such as in a virtual reality display device like VR glasses.

As shown in FIG. 1, the embodiment provides an interaction method for virtual scene, which may include:

S110: determine a target sketch in the virtual scene, in which the target sketch is obtained based on an operation inputted by the user.

An electronic device (e.g., a virtual reality display device such as VR glasses) may be able to lead the user to generate an experience of being in the virtual scene by closing the user's vision and hearing to the outside world. In some cases, the electronic device may respond to a user's access request/trigger operation of an interactive application within the electronic device to display the corresponding virtual scene to the user. In other cases, the electronic device may directly respond to a user's power-on trigger operation of the device to display the corresponding virtual scene to the user.

When the user is in the virtual scene via the electronic device, the device may capture the operation inputted by the user via a connected hardware device (e.g., a joystick, glove, camera, touch screen, or sensor, etc.). The operations may be applied to controls displayed in the virtual scene or may be used to bring up undisplayed controls for operations such as drawing, storing, and reading of a sketch. Further, a target sketch may be determined based on the currently drawn sketch or reading a stored drawn sketch for use in implementing interactions in the virtual scene via the target sketch.

In some optional implementations, determining the target sketch in the virtual scene may include at least one selected from the group of the following: receiving a drawing operation through a sketch drawing control of the virtual scene, generating the target sketch according to the drawing operation; receiving a first selection operation through a sketch selection control of the virtual scene, selecting a candidate sketch from the drawn sketch according to the first selection operation, and determining the target sketch according to the candidate sketch.

Exemplarily, FIG. 2 is a schematic diagram of an interface for determining a target sketch in an interaction method for virtual scene provided by embodiments of the present disclosure. Figure (a) in FIG. 2 shows an interface for generating a target sketch through a sketch drawing control, and Figure (b) in FIG. 2 shows an interface for determining a target sketch through a sketch selection control.

Referring to the Figure (a) in FIG. 2, the sketch drawing control such as a drawing board 211, a brush 212, and the like may be called up in the virtual scene according to the operation inputted by the user (e.g., the operation of the user pressing a certain button of the handle). The drawing board 211 may be facing the direction of the user's line of sight, and the size of the drawing board 211 may be adjusted. The brush 212 is not limited to the style shown in the figure, for example, it may also be a laser ray style, and the intersection of the laser ray and the drawing board may be used as the point of the pen. In addition, the brush 212 may be changed to draw the thickness of the line, the color of the line etc.

The drawing operation may include, but are not limited to, drawing, erasing, moving, copying, mirroring, and rotating etc. The sketch drawing control receives the drawing operation and presents the drawn sketch on the drawing board 211. The completed sketch may be stored and identified as the target sketch based on user input related to the drawing completion operation, and the sketch drawing control such as the drawing board 211 and the brush 212 may be hidden.

In some further implementations, the drawing operation includes drawing operations inputted by at least two clients. In these further implementations, the client may refer to an application installed within the electronic device for the user to log in, such as a virtual social application. When the clients of at least two electronic devices logs in, the at least two clients may perform an online operation so that the at least two electronic devices may display the same virtual scene as well as the same sketch drawing control. Accordingly, the sketch drawing control may receive drawing operations inputted by the at least two client to collaboratively complete the drawing of the target sketch, and this multi-person collaborative sketch drawing interaction may improve the user interaction experience.

Referring to Figure (b) in FIG. 2, the sketch selection control 221 may be called up in the virtual scene based on the operation inputted by the user (e.g., the user pressing another button of the handle), and the sketch selection control 221 may read a stored drawn sketch and may present a thumbnail 222 of the drawn sketch in a display window of the sketch selection control 221. Further, a first selection operation inputted by the user is received by the sketch selection control 221, and a candidate sketch is selected from the drawn sketch according to the first selection operation.

The candidate sketch may be directly used as the target sketch.

In addition, in some optional implementations, determining the target sketch according to the candidate sketch may also include: loading the candidate sketch into the sketch drawing control; receiving the drawing operation through the sketch drawing control, updating the candidate sketch according to the drawing operation to obtain the target sketch. In these optional implementations, certain modifications and updates may be made to the candidate sketch based on the drawing operation, and the updated candidate sketch may be stored and determined to be the target sketch, thereby realizing the determination of the target sketch based on a variety of methods, which is more flexible and convenient.

After determining the target sketch, an object category of each object included in the target sketch may be recognized by an existing image classification algorithm. The image classification algorithm may include traditional algorithms such as Local Binary Pattern (LBP) feature extraction algorithm, Histogram of Oriented Gradient (HOG) feature extraction algorithm etc., and it may also include machine learning algorithms such as K-Nearest Neighbor Algorithm (KNN), Support Vector Machine (SVM) etc., which are not exhaustive here. The object category may include, but is not limited to, the category of various objective objects such as animals, plants, artifacts, natural phenomena, etc., and may also include further subcategory of the above example category, which is not exhaustive herein.

S120: determine a target setting item of the virtual scene, in which the target setting item is configured to set at least a portion of at least one of visual data or auditory data of the virtual scene.

A setting interface may be predefined in the electronic device, and each setting item may be set by invoking the interface to change the corresponding visual data and/or auditory data of the virtual scene.

The target setting item may be considered to be a setting item that the target sketch needs to act upon. At least one setting item selected by default from the plurality of setting items of the virtual scene may be considered as the target setting item, or at least one setting item that the target sketch needs to act on may be determined as the target setting item by a user-specified manner and/or an automatically recognized manner.

In some optional implementations, determining the target setting item of the virtual scene may include at least one selected from the group of the following: receiving a second selection operation through a setting item selection control of the virtual scene, selecting the target setting item from respective setting item according to the second selection operation; matching the target setting item from the respective setting items according to the object category of the object in the target sketch that has been recognized.

In these optional implementations, user specification of the target setting items may be realized by the setting item selection control, for example, the respective setting item may be presented in a display window of the setting item selection, and the target setting item may be selected from the respective setting item based on the second selection operation inputted by the user. Alternatively, the target setting item may be automatically recognized by matching according to the object category of the object in the identified target sketch, for example, setting the setting item corresponding to respective object category in advance and matching the setting item corresponding to the identified object category as the target setting item. In addition, when the object category corresponds to more than two setting items, the setting items corresponding to the object category may also be displayed; thereby, the target setting item may be selected from the corresponding setting item according to a third selection operation inputted by the user. The determination of the target setting item by the user-specified manner and/or the automatically recognized manner can make the determination of the target setting item more flexible and varied.

S130: update a portion of the virtual scene corresponding to the target setting item according to an object category of an object in the target sketch.

In the embodiments of the present disclosure, relevant resource data for respective object category may be pre-made and stored, and the relevant resource data may include, but is not limited to, visual data and auditory data corresponding to the object category, such as two-dimensional image data, three-dimensional image data, audio data, and the like. Further, the resource data corresponding to the recognized object category may be read from the stored resource data according to the target setting item. And the corresponding portion of the virtual scene may be updated according to the read resource data, so that the interaction for virtual scene based on the sketch may be realized.

In the present embodiment, the drawing sketch can provide richer information than speech and text, and compared to the traditional simple interaction commands corresponding to input and hardware, the various interactions in the virtual scene through the semantic recognition results based on the target sketch form a more flexible and quicker interaction method, which can improve the user experience.

The technical solution of the embodiments of the present disclosure determines the target sketch in the virtual scene; determines the target setting item of the virtual scene; and updates the portion of the virtual scene corresponding to the target setting item according to the object category of the object in the target sketch. The embodiments of the present disclosure can update the portion of the virtual scene corresponding to the target setting item according to the result of recognizing the object category of the object in the target sketch, which can enrich the interaction method in the virtual reality scene and can improve the quickness of interaction, so that the user interaction experience can be improved.

The embodiments of the present disclosure may be combined with various optional programs in the interaction method for virtual scene provided by the above embodiments. In the interaction method of the virtual scene provided in the present embodiment, the target setting item may include an environment setting item. The environment setting item may present visual information of the base environment in the virtual scene by setting an environment map. The environment map generally refers mostly to a 360° panorama, the environment map shows a 360° panorama of the physical environment, which may include, for example, the sky, the ground, and environmental elements such as celestial bodies, birds, and flying equipment in the sky, and vegetation, building facilities, and other environmental elements on the ground, which are presented in their entirety as the environment map. The user may perceive the environmental information in a panoramic manner through the environment map presented by the electronic device. In the present embodiment, the environment map may be adjusted based on the recognition results of the target sketch to realize the update of the corresponding portion of the environment setting item in the virtual scene.

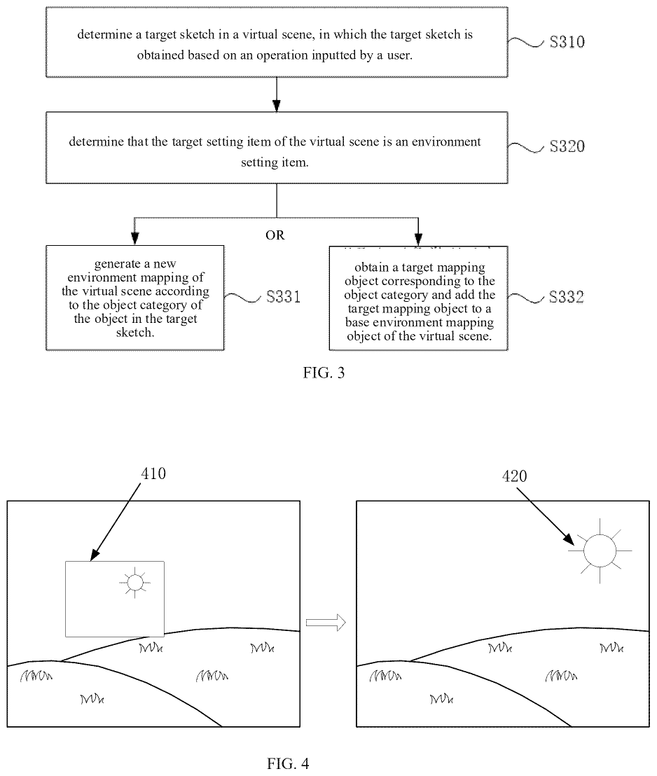

FIG. 3 is a schematic flow diagram of an interaction method for virtual scene provided by embodiments of the present disclosure. As shown in FIG. 3, the interaction method for virtual scene provided by the present embodiment may include:

S310: determine a target sketch in a virtual scene, in which the target sketch is obtained based on an operation inputted by a user.

S320: determine that the target setting item of the virtual scene is an environment setting item.

In the present embodiment, the target setting item may be determined to be an environment setting item by a user-specified manner and/or an automatically recognized manner.

In the case where the environment setting item is determined to be the target setting item by the automatically recognized manner, the object category having the environmental attributes may be set in advance to correspond to the environment setting item, and/or some object categories corresponding to the environment setting item may be directly preset. The category of the object having the environmental attributes may be determined, for example, based on the spatial location of the object in the real world, such as the sun, the moon, the clouds, and the meteors, etc. The spatial location of the objects in the real world is far away from the user, and the category of these objects may be set to correspond to the environment setting item.

The category of the object in the sketch may then be recognized, and when the recognized category of the object belongs to the category corresponding to the preset environment setting item, the target setting item of the virtual scene may be determined to be the environment setting item.

S331: generate a new environment map of the virtual scene according to the object category of the object in the target sketch.

In some cases, the environment map of the virtual scene may be an overall map. At this time, generating the new environment map of the virtual scene according to the object category of the object in the target sketch may include at least one selected from the group of the following: generating a completely new environment map according to the object category of the object in the target sketch, and the new environment map may be utilized to replace the original environment map in the virtual scene as a whole; locally updating the current environment map of the virtual scene according to the object category of the object in the target sketch to generate a new environment map for the virtual scene.

The current environment map is locally updated, for example, by adding the object in the target sketch to the current environment map, utilizing the object in the target sketch to replace the object that are mutually exclusive in the current environment map, or deleting the original object in the current environment map, etc. The different objects are mutually exclusive may be considered to have a smaller probability of different objects existing simultaneously in the same environment, for example, the sun object and the moon object may be considered to be mutually exclusive. The relationship of the mutually exclusive between different objects may be set in advance.

An entirely new environment map may be generated or a current environment map may be locally updated by an existing image generation model.

In some implementations, when the target sketch is a target sketch obtained by updating a candidate sketch according to a drawing operation, the step of generating the environment map by the image generation model may include: determining an updated area in the target sketch compared to the candidate sketch; updating a first area corresponding to the updated area in a semantic segmentation map corresponding to the candidate sketch; and, at least based on an updated semantic segmentation map and the environment map corresponding to the candidate sketch, generating the environment map corresponding to the target sketch by the image generation model.

The interaction apparatus may simultaneously maintain three images: a sketch, a semantic segmentation map and an environment map. Each pixel of the sketch and each element of the semantic segmentation map may have a correspondence, and a value of an element of the semantic segmentation map may characterize semantic information of the corresponding pixel of the sketch. The image classification result of the environment map is usually consistent with the image classification result of the sketch.

The updated area may be considered as the difference area of the target sketch compared to the candidate sketch. The contour area of respective object in the target sketch may be determined based on a conventional convex packet algorithm, edge detection algorithm, and/or based on an existing image segmentation model. The contour area of the respective object in the candidate sketch may be previously determined and stored, and may be read directly from the storage location. The contour area of the respective object in the target sketch and the contour area of the respective object in the candidate sketch may be aligned, and a non-overlapping area may be determined after the alignment. The updated area may be determined based on the non-overlapping area. For example, the non-overlapping area is directly used as the updated area, or the non-overlapping area with an area larger than a predetermined area is used as the updated area, etc.

After an incremental drawing of the updated area is performed, the first area corresponding to the updated area within the semantic segmentation map corresponding to the candidate sketch may be incrementally updated. The incremental updating of the first area may be understood as the unchanged values of the elements outside the first area within the semantic segmentation diagram, and only the values of the elements within the first area are updated. The semantic features may be extracted from the updated area by an existing network with semantic extraction function, and the extracted semantic features may be utilized to replace the values of the elements within the first area to realize the incremental updating of the first area.

The image generation model may be trained in advance to simultaneously utilize the updated semantic information and information in the environment map corresponding to the candidate sketch to generate a new environment map including object semantically identical to the updated area based on the original environment map, i.e., to generate the environment map corresponding to the target sketch. The image generation model may generate the environment map corresponding to the target sketch based on the updated semantic segmentation map and at least one feature of the local and global environment map corresponding to the candidate sketch.

In these implementations, the semantic segmentation map may be incrementally updated based on an updated area of the target sketch compared to the candidate sketch, so that semantic segmentation of the entire image of the sketch can be avoided, and computational resource consumption can be reduced. Moreover, a new environment map including object semantically identical to the updated area may be generated by the image generation model based on the updated semantic segmentation map and the information in the original environment map, which may reduce the computational resources consumed in the process of generating the environment map to a certain extent.

In some further implementations, after determining the updated area, it may further includes: processing (e.g., clearing) the second area corresponding to the updated area in the environment map corresponding to the candidate sketch; accordingly, generating the environment map corresponding to the target sketch by the image generation model based at least on the updated semantic segmentation map and the environment map corresponding to the candidate sketch may include: generating the environment map corresponding to the target sketch by the image generation model based at least on the updated semantic segmentation map and the environment map after processing the second area.

In these further implementations, information in the original environment map that is not related to the updated area is largely preserved by processing the area corresponding to the updated area in the environment map corresponding to the candidate sketch. Further, a new environment map including object semantically identical to the updated area may be generated based on the original environment map by the image generation model according to the updated semantic segmentation map and information of the portion of the original environment map that does not relate to the updated area, which can reduce computational resources consumed in the process of generating the environment map to a certain extent.

S332: obtain a target map object corresponding to the object category and add the target map object to a base environment map object of the virtual scene. In other cases, the environment map of the virtual scene may be a detachable map made by superimposing respective map object on the base environment map object. S331 and S332 may be considered to be in an “or” relationship. The base environment map of the virtual scene may be considered to be a generic environment map of any environment map of the virtual environment, and the base environment map object may be empty in some implementations.

In these cases, an environment map object of the object category corresponding to the environment setting item may be pre-made. When it is determined that the target setting item is an environment setting item, a target map object corresponding to the object category may be selected from each pre-made environment map object, and the target map object may be added to the base environment map object of the virtual scene.

When the target map object is mutually exclusive with an existing environment map object in the virtual scene, the mutually exclusive environment map object in the virtual scene may also be removed while the target map object is added to the virtual scene. For example, when the target map object is a sun map, the existing environment map object in the virtual scene includes a moon map that is mutually exclusive with the sun map, and at this time, the moon map may be removed from the virtual scene while the sun map is pasted into the virtual scene.

In some optional implementations, adding the target map object to the base environment map object of the virtual scene may include: adding a target map object corresponding to the object to the base environment map object of the virtual scene according to position information of the object in the target sketch.

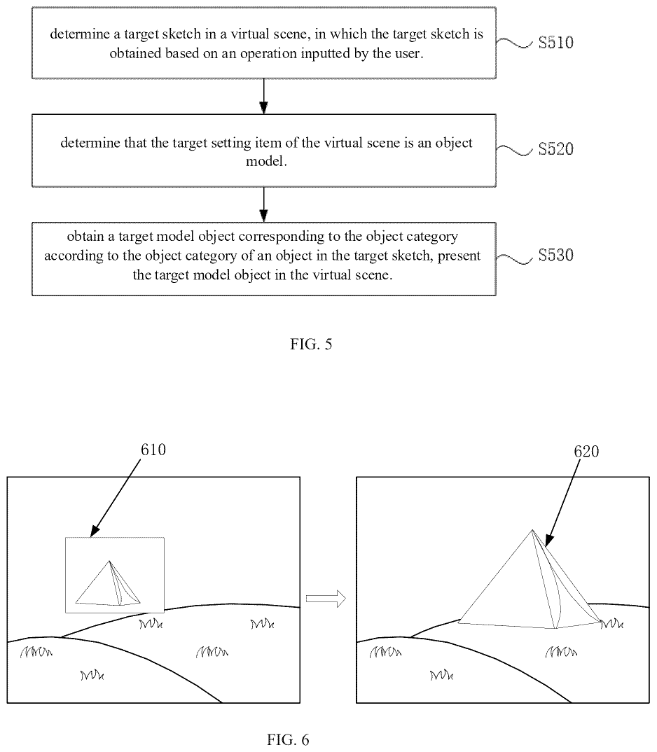

Exemplarily, FIG. 4 is a schematic diagram of an interface for updating an environment map in an interaction method for virtual scene provided by embodiments of the present disclosure. The environment map of the virtual scene shown in FIG. 4 may be considered as a detachable map made by superimposing respective map object on a base environment map object. Referring to FIG. 4, a sun object is drawn at a 45-degree position in the upper right corner of the target sketch 410. When the object category of the sun object is included in the object category corresponding to the environment setting item, the target setting item may be determined as the environment setting item. Next, the sun map object may be selected as the target map object from respective pre-made environment map object. Afterwards, the sun map object 420 may be added to a 45-degree position on the upper right under the user's viewpoint in the base environment map object of the virtual environment, so that it may be realized to add the target map object corresponding to the object to the base environment map object of the virtual scene according to the position information of the object in the target sketch.

In these optional implementations, the position information of the object contained in the sketch may be fully utilized to update the environment map of the virtual scene, which can make the modification of the virtual scene faster and smarter, and thus can improve the user experience.

In the technical solution of the embodiments of the present disclosure, the target setting item may include an environment setting item. The environment setting item may present visual information of the base environment in the virtual scene in the form of setting the environment map. In the present embodiment, the environment map may be adjusted based on the recognition result of the target sketch to realize the update of the corresponding portion of the environment setting item in the virtual scene. The interaction method for virtual scene provided by the embodiments of the present disclosure and the interaction method of the virtual scene provided by the embodiments described above belong to the same inventive concept, and technical details not exhaustively described in the present embodiments can be found in the above embodiment, and the same technical features have the same beneficial effect in the present embodiment and the above embodiments.

The embodiments of the present disclosure can be combined with each optional implementation in the interaction method for virtual scene provided by the above embodiments. In the interaction method for virtual scene provided by the present embodiment, the target setting item includes an object model, so that modification of the object model placed in the virtual scene based on the recognition result of the target sketch can be realized.

FIG. 5 is a flow diagram of an interaction method for virtual scene provided by embodiments of the present disclosure. As shown in FIG. 5, the interaction method for virtual scene provided by the present embodiment may include:

S510: determine a target sketch in a virtual scene, in which the target sketch is obtained based on an operation inputted by the user.

S520: determine that the target setting item of the virtual scene is an object model.

In the present embodiment, the target setting item may be determined to be an object model by a user-specified manner and/or an automatically recognized manner. In the case where the object model is determined to be the target setting item by the automatically recognized manner, an object category corresponding to the object model may be predefined. When the recognized object category is included in the object category corresponding to the object model, the target setting item may be determined to be the object model.

S530: obtain a target model object corresponding to the object category according to the object category of an object in the target sketch, present the target model object in the virtual scene.

The target model object may be generated in real time according to the object category of the object in the target sketch by an existing generation model and presented in the virtual scene.

In addition, in order to accelerate the presenting efficiency of the model object, respective model object of the object category corresponding to the object model may also be pre-made. When the target setting item is determined to be an object model, the target model object having the same semantics as the object category may be retrieved from the respective model object, and the target model may be presented in the virtual scene. When the retrieval result is empty, the target model object may also be generated based on the existing generation model. It may be considered that there is an “and/or” relationship between the above two ways of obtaining the target model object.

The target model object corresponding to the object may be presented at a corresponding position in the virtual scene based on the position information of the object in the target sketch. For example, there is a tent object drawn in the right part of the target sketch. When the object category of the tent object is included in the object category corresponding to the object model, the target setting item may be determined as the object model, and the tent model object may be retrieved from respective model object as the target model object. Thereafter, the tent model object is presented at a position to the right of the user's location in the virtual scene, thereby realizing that the target model object corresponding to the object is presented at a corresponding position in the virtual scene according to the position information of the object in the target sketch.

An association relationship between the model objects may be set in advance. Afterward, the target model object may be presented at the corresponding position in the virtual scene according to the association relationship between the target model object and the existing model object in the virtual scene. For example, when the target model object is a chair, and a table with an association relationship with the chair already exists in the virtual scene, the chair may be presented at a location near the table in the virtual scene.

In addition, in some optional implementations, presenting the target model object in the virtual scene may include at least one selected from the group of the following: presenting the target model object in the virtual scene according to a predefined animation; and presenting a target model object corresponding to the object in the virtual scene according to orientation information of the object in the target sketch.

In these optional implementations, the predefined animation may be a model presenting animation, which may include, but is not limited to, the model as a whole falling from above, the model being built from the bottom to the top blocks, the model being flown in and flashed, and the like. By presenting the target model object in the virtual scene according to the predefined animation, the model generation can be made more interesting in order to improve the user experience.

In addition, the model object may be a three-dimensional model object that may be displayed in different forms at different viewpoints. When generating the target model object, the target model object corresponding to the orientation information of the object may be presented in the virtual scene according to the orientation information of the object in the target sketch. Exemplarily, FIG. 6 is a schematic diagram of an interface for updating an object model in an interaction method for virtual scene provided by embodiments of the present disclosure. Referring to FIG. 6, when the orientation of the tent object in the target sketch 610 is 45 degrees to the right, then the tent model object 620 presented in the virtual scene may also be 45 degrees to the right.

In the present embodiment, the position, orientation, semantics, and other information of the object included in the sketch may be fully utilized to present the target object model in the virtual scene, which may make the way of presenting the model object in the virtual scene more flexible and convenient, and thus may improve the user experience.

In some optional implementations, after presenting the target model object, it may further include: receiving a model editing operation through a model editing control of the virtual scene, and editing the target model object according to the model editing operation; and the model editing operation includes at least one selected from the group of the following: rotating, scaling, and translation. In these optional implementations, after generating the target model object, the model editing control may also be invoked to receive the editing operation of the target model object to realize the editing of the target model object such as rotating, scaling, and translation, which can be conducive to adjusting the target model object to the state that the user is most satisfied with, and can further improve the user experience.

In the technical solution of the embodiments of the present disclosure, the target setting item includes an object model, which can thereby realize the modification of the object model placed in the virtual scene based on recognition of the target sketch. The interaction method for virtual scene provided by the embodiments of the present disclosure and the interaction method for virtual scene provided by the embodiments described above belong to the same disclosure idea, and technical details not exhaustively described in the present embodiments can be found in the embodiments described above, and the same technical features have the same beneficial effect in the present embodiment and the embodiments described above.

The embodiments of the present disclosure can be combined with each optional implementation in the interaction method for virtual scene provided by the above embodiments. In the interaction method for virtual scene provided by the present embodiment, the target setting item includes a weather system and/or a geomorphic system, so that a change of the weather and/or the geomorphic in the virtual scene based on the recognition result of the target sketch can be realized.

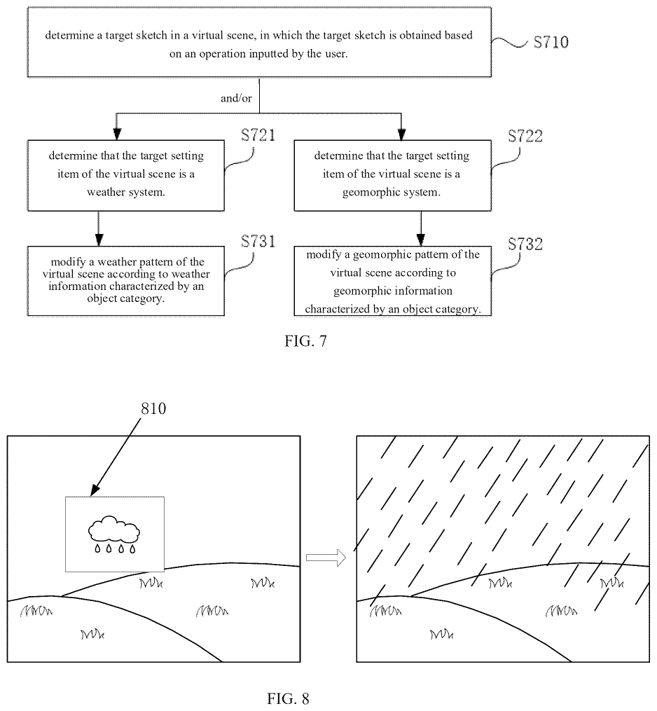

FIG. 7 is a flow diagram of an interaction method for virtual scene provided by embodiments of the present disclosure. As shown in FIG. 7, the interaction method for virtual scene provided by the present embodiment includes:

S710: determine a target sketch in the virtual scene, in which the target sketch is obtained based on an operation inputted by the user.

S721: determine that the target setting item of the virtual scene is a weather system.

In the present embodiment, the target setting item may be determined to be a weather system by a user-specified manner and/or an automatically recognized manner. In the case of determining the weather system as the target setting item by the automatically recognized manner, an object category corresponding to the weather system may be predefined, such as rain, snow, cloudy, daytime, nighttime, and the like. When the recognized object category is included in the object category corresponding to the weather system, the target setting item may be determined as the weather system.

S731: modify a weather pattern of the virtual scene according to weather information characterized by an object category.

In the present embodiment, various types of weather patterns in the virtual scene may be pre-made, and the weather patterns may include, in addition to visual data (e.g., static visual data, dynamic visual data, etc.), auditory data that matches the visual data. When a target setting item is determined to be the weather system, a corresponding weather pattern may be set for the virtual scene based on the weather information characterized by the object category. Exemplarily, FIG. 8 is a schematic diagram of an interface for updating the weather of a virtual scene in an interaction method for virtual scene provided by embodiments of the present disclosure. Referring to FIG. 8, when the weather information characterized by the object category in the target sketch 810 is rain, the virtual scene may be set to a rain mode, and dynamic visual data of rain falling may be played in the virtual scene, as well as auditory data of rain being played, so as to provide the user with the experience of being in the rain visually and aurally.

In another embodiment, when the object category of the object in the target sketch is the sun/moon, the environment setting item and the weather system may be determined as the target setting item at the same time. At this time, in addition to adjusting the environment map to include the sun/moon, the weather mode of the virtual scene may be modified to a day/night mode, for example, by adjusting visual data such as the brightness of ambient light, color temperature, etc., and by playing the barking data of the day/night-infested animals, etc.

S722: determine that the target setting item of the virtual scene is a geomorphic system.

In the present embodiment, the target setting item may be determined to be a geomorphic system by a user-specified manner and/or an automatically recognized manner. In the case where the geomorphic system is determined to be the target setting item by the automatically recognized manner, an object category corresponding to the geomorphic system, such as a mountain, a river, and the like, may also be predefined. When the recognized object category is included in the object category corresponding to the geomorphic system, the target setting item may be determined as the geomorphic system.

S732: modify a geomorphic pattern of the virtual scene according to geomorphic information characterized by an object category.

In the present embodiment, various types of geomorphic patterns in the virtual scene may be pre-made, and the geomorphic patterns may include auditory data that matches the visual data in addition to visual data. The geomorphic mode may provide more options of geomorphic types for the surface portion of the virtual scene, and may be combined with the adjustment of the environment map setting item to realize a more diverse virtual scene presentation and improve the user experience.

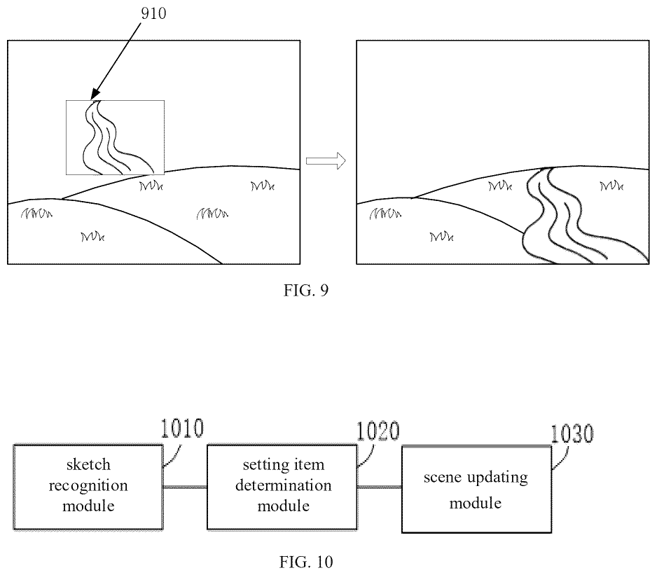

When it is determined that the target setting item is a geomorphic system, a corresponding geomorphic pattern may be modified for the virtual scene according to the geomorphic information characterized by the object category. Exemplarily, FIG. 9 is a schematic diagram of an interface for updating the geomorphic of a virtual scene in an interaction method for virtual scene provided by embodiments of the present disclosure. Referring to FIG. 9, when the geomorphic information characterized by the object category in the target sketch 910 is a river, a river pattern may be added to the original geomorphic pattern of the virtual scene, for example, a river is added to the original grassland, and auditory data that is matched with the river is played synchronously to realize the modification of the geomorphic pattern of the virtual scene.

S721, S731 and S722, S732 are in an “and/or” relationship, that is, when the target setting item is a weather system or a geomorphic system, the weather or the geomorphic of the virtual scene is modified; when the target setting item is a weather system or a geomorphic system, the weather or the geomorphic of the virtual scene is modified.

In the technical solution of the embodiments of the present disclosure, the target setting item includes the weather system and/or the geomorphic system, so as to realize the modification of the weather and/or the geomorphic in the virtual scene based on the recognition result of the target sketch. The interaction method for virtual scene provided by the embodiments of the present disclosure and the interaction method for virtual scene provided by the embodiments described above belong to the same disclosure idea, and technical details not exhaustively described in the present embodiments can be found in the embodiments described above, and the same technical features have the same beneficial effect in the present embodiment and the embodiments described above.

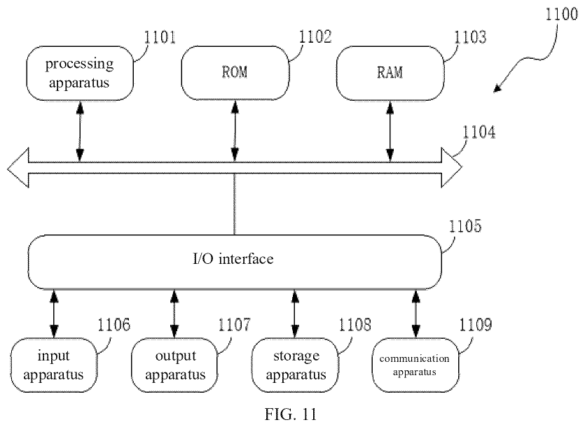

FIG. 10 is a structural schematic diagram of an interaction apparatus for virtual scene provided by embodiments of the present disclosure. The interaction apparatus for virtual scene provided by the present embodiment is suitable for situations where modifications are made to different parts of a virtual scene.

As shown in FIG. 10, the interaction apparatus for virtual scene provided by the present embodiments of the disclosure may include: a sketch recognition module 1010, a setting item determination module 1020 and a scene updating module 1030.

The sketch recognition module 1010 is configured to determine a target sketch in a virtual scene, and the target sketch is obtained based on an operation inputted by a user.

The setting item determination module 1020 is configured to determine a target setting item of the virtual scene, and the target setting item is configured to set at least a portion of at least one of visual data or auditory data of the virtual scene.

The scene updating module 1030 is configured to update a portion of the virtual scene corresponding to the target setting item according to an object category of an object in the target sketch.

In some optional implementations, the sketch recognition module may be configured to determine the target sketch in the virtual scene based on at least one selected from the group of the following:
receive a drawing operation through a sketch drawing control of the virtual scene, generate the target sketch according to the drawing operation;
receive a first selection operation through a sketch selection control of the virtual scene, select a candidate sketch from the drawn sketch according to the first selection operation, and determine the target sketch according to the candidate sketch.

In some optional implementations, the drawing operation includes drawing operations inputted by at least two clients.

In some optional implementations, the sketch recognition module, may further be configured to:
load the candidate sketch into the sketch drawing control;
receive the drawing operation through the sketch drawing control, and update the candidate sketch according to the drawing operation to obtain the target sketch.

In some optional implementations, the setting item determination module may be configured to determine the target setting item of the virtual scene based on at least one selected from the group of the following:
receive a second selection operation through a setting item selection control of the virtual scene, select the target setting item from respective setting items according to the second selection operation;
match the target setting item from the respective setting item according to the object category of the object in the target sketch that has been recognized.

In some optional implementations, the target setting item includes an environment setting item; the scene updating module may be configured to:
generate a new environment map of the virtual scene according to the object category of the object in the target sketch;
or, obtain a target map object corresponding to the object category and add the target map object to a base environment map object of the virtual scene.

In some optional implementations, the scene updating module may be configured to:
add a target map object corresponding to the object to the base environment map object of the virtual scene according to position information of the object in the target sketch.

In some optional implementations, the target setting item includes an object model; the scene updating module may be configured to:
obtain a target model object corresponding to the object category according to the object category of an object in the target sketch, presenting the target model object in the virtual scene.

In some optional implementations, the scene updating module may be used to perform at least one selected from the group of the following:
generate the target model object in the virtual scene according to a predefined animation;
generate a target model object corresponding to the object in the virtual scene according to the orientation information of the object in the target sketch.

In some optional implementations, the scene updating module may further be configured to:
receive a model editing operation through a model editing control of the virtual scene after presenting the target model object, and edit the target model object according to the model editing operation;
the model editing operation includes at least one selected from the group of the following: rotating, scaling, and translation.

In some optional implementations, the target setting item includes a weather system and/or a geomorphic system; the scene updating module may be configured to:
modify a weather pattern of the virtual scene according to weather information characterized by an object category of an object in the target sketch; and/or
modify a geomorphic pattern of the virtual scene according to geomorphic information characterized by an object category of an object in the target sketch.

The interaction apparatus for virtual scene provided by the embodiments of the present disclosure can execute the interaction method for virtual scene provided by any embodiment of the present disclosure, and possesses functional modules and beneficial effects corresponding to the execution method.

It is worth noting that the various units and modules included in the above-described apparatus are only divided according to functional logic, but are not limited to the above-described division, as long as the corresponding functions can be realized; furthermore, the specific names of the various functional units are only for the purpose of facilitating differentiation from each other, and are not used to limit the scope of protection of the embodiments of the present disclosure.

Reference is made to FIG. 11 below, which is a structural schematic diagram of an electronic device 1100 suitable for implementing the embodiments of the present disclosure. The terminal device in the embodiment of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 11 is merely an example, and should not pose any limitation to the functions and the range of use of the embodiments of the present disclosure.

As illustrated in FIG. 11, the electronic device 1100 may include a processing apparatus (e.g., a central processing unit, a graphics processing unit, etc.) 1101, which can perform various suitable actions and processing according to a program stored in a read-only memory (ROM) 1102 or a program loaded from a storage apparatus 1108 into a random-access memory (RAM) 1103. The RAM 1103 further stores various programs and data required for operations of the electronic device 1100. The processing apparatus 1101, the ROM 1102, and the RAM 1103 are interconnected by means of a bus 1104. An input/output (I/O) interface 1105 is also connected to the bus 1104.

Usually, the following apparatus may be connected to the I/O interface 1105: an input apparatus 1106 including, for example, a touch screen, a touch pad, a keyboard, a mouse, a camera, a microphone, an accelerometer, a gyroscope, or the like; an output apparatus 1107 including, for example, a liquid crystal display (LCD), a loudspeaker, a vibrator, or the like; a storage apparatus 1108 including, for example, a magnetic tape, a hard disk, or the like; and a communication apparatus 1109. The communication apparatus 1109 may allow the electronic device 1100 to be in wireless or wired communication with other devices to exchange data. While FIG. 11 illustrates the electronic device 1100 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1109 and installed, or may be installed from the storage apparatus 1108, or may be installed from the ROM 1102. When the computer program is executed by the processing apparatus 1101, the above-mentioned functions defined in the method of the embodiments of the present disclosure are executed.

In some optional implementations, the electronic terminal may be a virtual reality display device (e.g., VR glasses, etc.); the virtual reality display device, which may further include: a display module, configured to display the virtual scene.

The electronic device provided by the embodiments of the present disclosure belongs to the same disclosure concept as the interaction method for virtual scene provided by the above embodiments, and technical details not exhaustively described in the present embodiments can be found in the above embodiments, and the present embodiments have the same beneficial effects as the above embodiments.

Embodiments of the present disclosure provide a computer storage medium having a computer program stored thereon, which the program when executed by a processor implements the interaction method for virtual scene provided by the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above computer-readable medium may be included in the above electronic device; or may also exist alone without being assembled into the electronic device.

The above computer-readable medium carries one or more programs. When the one or more programs are executed by the electronic device, the electronic device is caused to:
determine a target sketch in a virtual scene, and the target sketch is obtained based on an operation inputted by a user; determine a target setting item of the virtual scene, and the target setting item is configured to set at least a portion of at least one of visual data or auditory data of the virtual scene; update a portion of the virtual scene corresponding to the target setting item according to an object category of an object in the target sketch.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard parts (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, there is provided an interaction method for virtual scene, the method including:
determining a target sketch in a virtual scene, and the target sketch is obtained based on an operation inputted by a user;
determining a target setting item of the virtual scene, and the target setting item is configured to set at least a portion of at least one of visual data or auditory data of the virtual scene;
updating a portion of the virtual scene corresponding to the target setting item according to an object category of an object in the target sketch.

According to one or more embodiments of the present disclosure, there is provided an interaction method for virtual scene, the method further including:
in some optional implementations, the determining a target sketch in a virtual scene includes at least one selected from the group of the following:
receiving a drawing operation through a sketch drawing control of the virtual scene, generating the target sketch according to the drawing operation;
receiving a first selection operation through a sketch selection control of the virtual scene, selecting a candidate sketch from a drawn sketch according to the first selection operation, and determining the target sketch according to the candidate sketch.

According to one or more embodiments of the present disclosure, there is provided an interaction method for virtual scene, the method further including:
in some optional implementations, the drawing operation includes drawing operations inputted by at least two clients.

According to one or more embodiments of the present disclosure, there is provided an interaction method for virtual scene, the method further including:
in some optional implementations, the determining the target sketch according to the candidate sketch includes:
loading the candidate sketch into the sketch drawing control;
receiving the drawing operation through the sketch drawing control, updating the candidate sketch according to the drawing operation to obtain the target sketch.

According to one or more embodiments of the present disclosure, there is provided an interaction method for virtual scene, the method further including:
in some optional implementations, the determining a target setting item of the virtual scene includes at least one selected from the group of the following:
receiving a second selection operation through a setting item selection control of the virtual scene, selecting the target setting item from respective setting items according to the second selection operation;
matching the target setting item from the respective setting items according to the object category of the object in the target sketch that has been recognized.

According to one or more embodiments of the present disclosure, there is provided an interaction method for virtual scene, the method further including:
in some optional implementations, the target setting item includes an environment setting item; the updating a portion of the virtual scene corresponding to the target setting item according to an object category of an object in the target sketch including:
generating a new environment map of the virtual scene according to the object category of the object in the target sketch;
or, obtaining a target map object corresponding to the object category and adding the target map object to a base environment map object of the virtual scene.

According to one or more embodiments of the present disclosure, there is provided an interaction method for virtual scene, the method further including:
in some optional implementations, the adding the target map object to a base environment map object of the virtual scene includes:
adding a target map object corresponding to the object to the base environment map object of the virtual scene according to position information of the object in the target sketch.

According to one or more embodiments of the present disclosure, there is provided an interaction method for virtual scene, the method further including:
in some optional implementations, the target setting item includes an object model;
the updating a portion of the virtual scene corresponding to the target setting item according to an object category of an object in the target sketch including:
obtaining a target model object corresponding to the object category according to the object category of an object in the target sketch, presenting the target model object in the virtual scene.

According to one or more embodiments of the present disclosure, there is provided an interaction method for virtual scene, the method further including:
in some optional implementations, the presenting the target model object in the virtual scene includes at least one selected from the group of the following:
presenting the target model object in the virtual scene according to a predefined animation;
presenting a target model object corresponding to the object in the virtual scene according to orientation information of the object in the target sketch.

According to one or more embodiments of the present disclosure, there is provided an interaction method for virtual scene, the method further including:
in some optional implementations, after the presenting the target model object, and the interaction method for virtual scene further includes:
receiving a model editing operation through a model editing control of the virtual scene, and editing the target model object according to the model editing operation;
and the model editing operation includes at least one selected from the group of the following: rotating, scaling and translation.

According to one or more embodiments of the present disclosure, there is provided an interaction method for virtual scene, the method further including:
in some optional implementations, the target setting item includes a weather system and/or a geomorphic system; the updating a portion of the virtual scene corresponding to the target setting item according to an object category of an object in the target sketch including:
modifying a weather pattern of the virtual scene according to weather information characterized by an object category of an object in the target sketch; and/or
modifying a geomorphic pattern of the virtual scene according to geomorphic information characterized by an object category of an object in the target sketch.

According to one or more embodiments of the present disclosure, there is provided an interaction apparatus for virtual scene, the apparatus including:
a sketch recognition module, configured to determine a target sketch in a virtual scene, and the target sketch is obtained based on an operation inputted by a user;
a setting item determination module, configured to determine a target setting item of the virtual scene, and the target setting item is configured to set at least a portion of at least one of visual data or auditory data of the virtual scene; and
a scene updating module, configured to update a portion of the virtual scene corresponding to the target setting item according to an object category of an object in the target sketch.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or their equivalents without departing from the above disclosed concept, for example, a technical solution formed by replacing the above features with the technical features having similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Likewise, although several specific implementation details are contained in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or logical actions of the methods, it should be understood that the subject matter defined in the appended claims is not necessarily limited to the specific features or actions described above. Rather, the specific features and actions described above are merely example forms of implementing the claims. Regarding the apparatus in the above embodiments, the specific manner in which each module performs operations has been described in detail in the method embodiments, and will not be described in detail here.

1. An interaction method for virtual scene, comprising:
determining a target sketch in the virtual scene, wherein the target sketch is obtained based on an operation inputted by a user;
determining a target setting item of the virtual scene, wherein the target setting item is configured to set at least a portion of at least one of visual data or auditory data of the virtual scene; and
updating a portion of the virtual scene corresponding to the target setting item according to an object category of an object in the target sketch.

2. The interaction method for the virtual scene according to claim 1, wherein the determining a target sketch in the virtual scene comprises at least one selected from a group comprising following:
receiving a drawing operation through a sketch drawing control of the virtual scene, and generating the target sketch according to the drawing operation; and
receiving a first selection operation through a sketch selection control of the virtual scene, selecting a candidate sketch from at least one drawn sketch according to the first selection operation, and determining the target sketch according to the candidate sketch.

3. The interaction method for the virtual scene according to claim 2, wherein the drawing operation comprises drawing operations inputted by at least two clients.

4. The interaction method for the virtual scene according to claim 2, wherein the determining the target sketch according to the candidate sketch comprises:
loading the candidate sketch into the sketch drawing control; and
receiving the drawing operation through the sketch drawing control, and updating the candidate sketch according to the drawing operation to obtain the target sketch.

5. The interaction method for the virtual scene according to claim 1, wherein the determining a target setting item of the virtual scene comprises at least one selected from a group comprising following:
receiving a second selection operation through a setting item selection control of the virtual scene, and selecting the target setting item from respective setting items according to the second selection operation; and
matching the target setting item from the respective setting items according to the object category of the object in the target sketch that has been recognized.

6. The interaction method for the virtual scene according to claim 1, wherein the target setting item comprises an environment setting item; the updating a portion of the virtual scene corresponding to the target setting item according to an object category of an object in the target sketch comprises:
generating a new environment map of the virtual scene according to the object category of the object in the target sketch;
or, obtaining a target map object corresponding to the object category and adding the target map object to a base environment map object of the virtual scene.

7. The interaction method for the virtual scene according to claim 6, wherein the adding the target map object to a base environment map object of the virtual scene comprises:
adding the target map object corresponding to the object to the base environment map object of the virtual scene according to position information of the object in the target sketch.

8. The interaction method for the virtual scene according to claim 1, wherein the target setting item comprises an object model; the updating a portion of the virtual scene corresponding to the target setting item according to an object category of an object in the target sketch comprises:
obtaining a target model object corresponding to the object category according to the object category of the object in the target sketch, and presenting the target model object in the virtual scene.

9. The interaction method for the virtual scene according to claim 8, wherein the presenting the target model object in the virtual scene comprises at least one selected from a group comprising following:
presenting the target model object in the virtual scene according to a predefined animation; and
presenting the target model object corresponding to the object in the virtual scene according to orientation information of the object in the target sketch.

10. The interaction method for the virtual scene according to claim 8, wherein after the presenting the target model object, the interaction method for the virtual scene further comprises:
receiving a model editing operation through a model editing control of the virtual scene, and editing the target model object according to the model editing operation,
wherein the model editing operation comprises at least one selected from a group comprising following: rotating, scaling and translation.

11. The interaction method for the virtual scene according to claim 1, wherein the target setting item comprises a weather system and/or a geomorphic system; the updating a portion of the virtual scene corresponding to the target setting item according to an object category of an object in the target sketch comprises:
modifying a weather pattern of the virtual scene according to weather information characterized by the object category of the object in the target sketch; and/or
modifying a geomorphic pattern of the virtual scene according to geomorphic information characterized by the object category of the object in the target sketch.

12. (canceled)

13. An electronic device, comprising:
at least one processor; and
a storage apparatus, configured to store at least one program,
wherein, when the at least one program is executed by the at least one processor, the at least one processor implement an interaction method for virtual scene, and the method comprises:
determining a target sketch in the virtual scene, wherein the target sketch is obtained based on an operation inputted by a user;
determining a target setting item of the virtual scene, wherein the target setting item is configured to set at least a portion of at least one of visual data or auditory data of the virtual scene; and
updating a portion of the virtual scene corresponding to the target setting item according to an object category of an object in the target sketch.

14. The electronic device according to claim 13, wherein the electronic device is a virtual reality display device; and the virtual reality display device further comprises: a display module, configured to display the virtual scene.

15. A non-transitory storage medium comprising computer-executable instructions, wherein the computer-executable instructions, when executed by a computer processor, are used to implement an interaction method for virtual scene, and the method comprises:
determining a target sketch in the virtual scene, wherein the target sketch is obtained based on an operation inputted by a user;
determining a target setting item of the virtual scene, wherein the target setting item is configured to set at least a portion of at least one of visual data or auditory data of the virtual scene; and
updating a portion of the virtual scene corresponding to the target setting item according to an object category of an object in the target sketch.

16. The electronic device according to claim 13, wherein the determining a target sketch in the virtual scene comprises at least one selected from a group comprising following:
receiving a drawing operation through a sketch drawing control of the virtual scene, and generating the target sketch according to the drawing operation; and
receiving a first selection operation through a sketch selection control of the virtual scene, selecting a candidate sketch from at least one drawn sketch according to the first selection operation, and determining the target sketch according to the candidate sketch.

17. The electronic device according to claim 16, wherein the drawing operation comprises drawing operations inputted by at least two clients.

18. The electronic device according to claim 16, wherein the determining the target sketch according to the candidate sketch comprises:
loading the candidate sketch into the sketch drawing control; and
receiving the drawing operation through the sketch drawing control, and updating the candidate sketch according to the drawing operation to obtain the target sketch.

19. The electronic device according to claim 13, wherein the determining a target setting item of the virtual scene comprises at least one selected from a group comprising following:
receiving a second selection operation through a setting item selection control of the virtual scene, and selecting the target setting item from respective setting items according to the second selection operation; and
matching the target setting item from the respective setting items according to the object category of the object in the target sketch that has been recognized.

20. The electronic device according to claim 13, wherein the target setting item comprises an environment setting item; the updating a portion of the virtual scene corresponding to the target setting item according to an object category of an object in the target sketch comprises:
generating a new environment map of the virtual scene according to the object category of the object in the target sketch;
or, obtaining a target map object corresponding to the object category and adding the target map object to a base environment map object of the virtual scene.

21. The electronic device according to claim 20, wherein the adding the target map object to a base environment map object of the virtual scene comprises:
adding the target map object corresponding to the object to the base environment map object of the virtual scene according to position information of the object in the target sketch.
